(19) United States
(12) Patent Application Publication
(10) Pub. No.: US 2010/0332255 A1
(43) Pub. Date: Dec. 30, 2010

(54) SYSTEMS, METHODS, APPARATUSES, AND COMPUTER PROGRAM PRODUCTS FOR FACILITATING DISPLAY OF MEDICAL PROCEDURE DATA

(75) Inventor: James R. Rotunda, Suwanee, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/495,096

(22) Filed: Jun. 30, 2009

(51) Int. Cl. G06Q 50/00; G06Q 10/00; G06F 3/00

(52) U.S. Cl. 705/3; 705/2; 715/753

(57) ABSTRACT

Systems, methods, apparatuses, and computer program products are provided for facilitating display of medical procedure data on a surgical tracking display apparatus. A method may include accessing medical procedure data from one or more data sources. The method may further include aggregating the accessed medical procedure data into one or more procedure data units based at least in part upon predefined aggregation criteria. The method may additionally include assigning each procedure data unit to one of a plurality of groups and ordering the procedure data units for each group. The method may also include causing one or more ordered procedure data units from each of a plurality of the groups to be displayed in order on the surgical tracking display apparatus. Corresponding systems, apparatuses, and computer program products are also provided.

### TECHNOLOGICAL FIELD

Embodiments of the present invention relate generally to medical technology for use in hospitals and medical clinics and, more particularly, relate to systems, methods, apparatuses, and computer program products for facilitating display of medical procedure data.

### BACKGROUND

Hospitals and medical clinics may have multiple operating rooms in which surgery or other medical procedures are performed on patients according to a schedule. In this regard, several medical procedures may be scheduled in a single hospital or medical clinic in a single day and medical personnel including, for example, surgeons, anesthesiologists, or the like may need to keep track of the operating room schedules and data related to scheduled medical procedures, such as, for example, patient identity, responsible medical staff persons, patient status, medical procedure(s) scheduled to be performed on the patient, and/or the like. Currently, this medical procedure data may not be accessible from a single location and/or may not be aggregated and presented in a way to allow medical staff persons to easily view and understand a medical procedure schedule for the operating rooms of a hospital or medical clinic. Moreover, medical data may currently not be shared between areas of a hospital, thus resulting in medical personnel in a first area of a hospital having to contact medical personnel in a second area of the hospital to obtain medical data.

### BRIEF SUMMARY OF SOME EXAMPLES OF THE INVENTION

Systems, methods, apparatuses, and computer program products are therefore provided for facilitating for facilitating display of medical procedure data. In this regard, systems, methods, apparatuses, and computer program products are provided that may provide several advantages to medical personnel, patients, and computing devices. Embodiments of the invention provide an apparatus configured to access and aggregate medical procedure data from one or more data sources to generate medical procedure data units. Embodiments of the invention further provide an apparatus configured to cause the medical procedure data units to be displayed on a surgical tracking display apparatus so that medical personnel are enabled to easily view medical procedure data relating to medical procedures scheduled for operating rooms of a hospital or medical clinic. Embodiments of the invention additionally provide an apparatus configured to access medical data from and share medical data with a plurality of computing devices located in various areas of a hospital or medical clinic over a network.

In a first example embodiment, a method for facilitating display of medical procedure data on a surgical tracking display apparatus is provided, which comprises accessing medical procedure data from one or more data sources. The method of this embodiment further comprises aggregating the accessed medical procedure data into one or more procedure data units based at least in part upon predefined aggregation criteria. Each procedure data unit of this embodiment is associated with a patient, with an operating room in which a medical procedure is scheduled to be performed on the patient, and with the medical procedure scheduled to be performed on the patient. Each procedure data unit of this embodiment comprises an identification of the patient and a time at which the medical procedure is scheduled to be performed. The method of this embodiment also comprises assigning each procedure data unit to one of a plurality of groups. Each group of this embodiment is associated with a single operating room and each respective procedure data unit of this embodiment is assigned to the group associated with the operating room with which the respective procedure data unit is associated. The method of this embodiment additionally comprises ordering the procedure data units for each group such that the procedure data units are ordered within each group based at least in part upon the time at which the medical procedure is scheduled to be performed. The method of this embodiment further comprises causing one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

In another example embodiment, an apparatus for facilitating display of medical procedure data on a surgical tracking display apparatus is provided. The apparatus of this embodiment comprises at least one processor configured to cause the apparatus to at least access medical procedure data from one or more data sources. The at least one processor of this embodiment is further configured to cause the apparatus to aggregate the accessed medical procedure data into one or more procedure data units based at least in part upon predefined aggregation criteria. Each procedure data unit of this embodiment is associated with a patient, with an operating room in which a medical procedure is scheduled to be performed on the patient, and with the medical procedure scheduled to be performed on the patient. Each procedure data unit of this embodiment comprises an identification of the patient and a time at which the medical procedure is scheduled to be performed. The at least one processor of this embodiment is also configured to cause the apparatus to assign each procedure data unit to one of a plurality of groups. Each group of this embodiment is associated with a single operating room and each respective procedure data unit of this embodiment is assigned to the group associated with the operating room with which the respective procedure data unit is associated. The at least one processor of this embodiment is additionally configured to cause the apparatus to order the procedure data units for each group such that the procedure data units are ordered within each group based at least in part upon the time at which the medical procedure is scheduled to be performed. The at least one processor of this embodiment is further configured to cause the apparatus to cause one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

In another example embodiment, a computer program product for facilitating display of medical procedure data on a surgical tracking display apparatus is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is configured for accessing medical procedure data from one or more data sources. The second program instruction of this embodiment is configured for aggregating the accessed medical procedure data into one or more procedure data units based at least in part upon predefined aggregation criteria. Each procedure data unit of this embodiment is associated with a patient, with an operating room in which a medical procedure is scheduled to be performed on the patient, and with the medical procedure scheduled to be performed on the patient. Each procedure data unit of this embodiment comprises an identification of the patient and a time at which the medical procedure is scheduled to be performed. The third program instruction of this embodiment is configured for assigning each procedure data unit to one of a plurality of groups. Each group of this embodiment is associated with a single operating room and each respective procedure data unit of this embodiment is assigned to the group associated with the operating room with which the respective procedure data unit is associated. The fourth program instruction of this embodiment is configured for ordering the procedure data units for each group such that the procedure data units are ordered within each group based at least in part upon the time at which the medical procedure is scheduled to be performed. The fifth program instruction of this embodiment is configured for causing one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

In another example embodiment, an apparatus for facilitating display of medical procedure data on a surgical tracking display apparatus is provided that comprises means for accessing medical procedure data from one or more data sources. The apparatus of this embodiment further comprises means for aggregating the accessed medical procedure data into one or more procedure data units based at least in part upon predefined aggregation criteria. Each procedure data unit of this embodiment is associated with a patient, with an operating room in which a medical procedure is scheduled to be performed on the patient, and with the medical procedure scheduled to be performed on the patient. Each procedure data unit of this embodiment comprises an identification of the patient and a time at which the medical procedure is scheduled to be performed. The apparatus of this embodiment also comprises means for assigning each procedure data unit to one of a plurality of groups. Each group of this embodiment is associated with a single operating room and each respective procedure data unit of this embodiment is assigned to the group associated with the operating room with which the respective procedure data unit is associated. The apparatus of this embodiment additionally comprises means for ordering the procedure data units for each group such that the procedure data units are ordered within each group based at least in part upon the time at which the medical procedure is scheduled to be performed. The apparatus of this embodiment further comprises means for causing one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for facilitating display of medical procedure data on a surgical tracking display apparatus according to an exemplary embodiment of the present invention;

FIG. 2 illustrates a block diagram of an apparatus for facilitating display of medical procedure data on a surgical tracking display apparatus according to an exemplary embodiment of the present invention;

FIG. 3 illustrates a screen capture of an operating room worklist for entering medical procedure data according to an exemplary embodiment of the present invention;

FIG. 4 illustrates a screen capture of an operating room assignment worklist according to an exemplary embodiment of the invention;

FIG. 5 illustrates a perspective view of a surgical tracking display apparatus according to an exemplary embodiment of the invention;

FIG. 6 illustrates medical procedure data displayed on a surgical tracking display apparatus according to an exemplary embodiment of the present invention;

FIG. 7 illustrates medical procedure data displayed on a surgical tracking display apparatus according to an exemplary embodiment of the present invention;

FIG. 8 illustrates medical procedure data displayed on a surgical tracking display apparatus according to an exemplary embodiment of the present invention;

FIG. 9 illustrates medical procedure data displayed on a surgical tracking display apparatus according to an exemplary embodiment of the present invention;

FIG. 10 illustrates a screen capture of a waiting room worklist according to an exemplary embodiment of the present invention;

FIG. 11 illustrates medical data displayed on a post-anesthesia care unit display apparatus according to an exemplary embodiment of the present invention;

FIG. 12 illustrates medical data displayed on a short stay display apparatus according to an exemplary embodiment of the present invention;

FIG. 13 illustrates a screen capture of a short stay worklist according to an exemplary embodiment of the present invention; and

FIG. 14 illustrates a flowchart according to an exemplary method for facilitating display of medical procedure data on a surgical tracking display apparatus according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

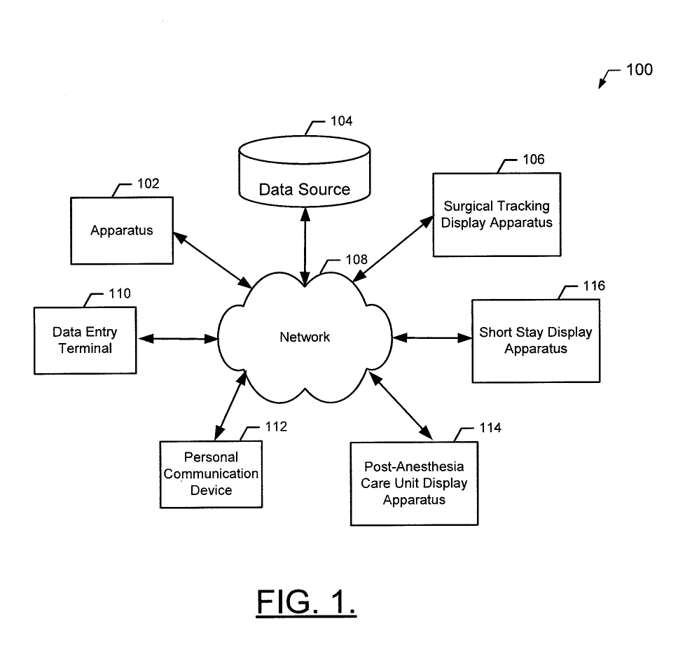

FIG. 1 illustrates a system 100 for facilitating display of medical procedure data on a surgical tracking display apparatus according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. I illustrates one example configuration of a system for facilitating display of medical procedure data on a surgical tracking display apparatus, numerous other configurations may also be used to implement embodiments of the present invention.

In an exemplary embodiment, the system 100 comprises an apparatus 102, one or more data sources 104, and a surgical tracking display apparatus 106 in communication over a network 108. The network 108 may comprise one or more wireline networks, one or more wireless networks (e.g., a wireless local area network, cellular network, and/or the like), or a combination thereof, and in one embodiment comprises the Internet.

In an exemplary embodiment, the apparatus 102 comprises one or more computing devices configured to facilitate display of medical procedure data on a surgical tracking display apparatus 106 as will be described further herein. The one or more computing devices may comprise, for example, one or more servers, one or more desktop computers, one or more laptop computers, one or more mobile terminals, one or more mobile communication devices, any combination thereof, and/or the like. In embodiments wherein the apparatus 102 comprises multiple computing devices, the multiple computing devices may be in operative communication with each other, such as over the network 108 to collectively perform one or more functionalities of the apparatus 102 as described herein.

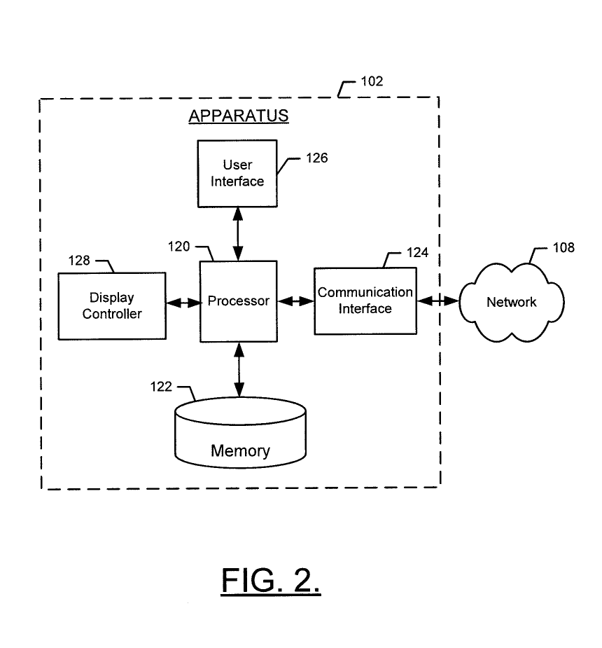

In an exemplary embodiment, a data source 104 comprises one or more memories storing medical procedure data, such as in a database. The one or more memories may be accessible by the apparatus 102 over the network 108. A data source 104 may be embodied as one or more memories of any computing device or combination of computing devices, such as, for example, a memory of the apparatus 102 (e.g., the memory 122 illustrated in FIG. 2), a memory of a data entry terminal 110, a memory of a personal communication device 112, or a combination thereof. In another example, a data source 104 may be embodied on a dedicated device, such as a network-accessible storage device that is accessible by the apparatus 102 over the network 108.

The surgical tracking display apparatus 106 may comprise any apparatus comprising one or more displays that is configured to receive and/or access data for display over the network 108 and display the data on at least one of the one or more displays. In an exemplary embodiment, the surgical tracking display apparatus 106 comprises one or more displays located in a surgical area of a hospital or medical clinic, such as, for example, outside of an operating room.

In some embodiments, the system 100 may additionally comprise one or more data entry terminals 110, one or more personal communication devices 112, a post-anesthesia care unit display apparatus 114, and/or a short stay display apparatus 116. A data entry terminal 110 may comprise, for example a computing device (e.g., a desktop computer, laptop computer, mobile computer, or the like) through which a medical staff person (e.g., a nurse, hospital administrator, doctor, or other approved hospital/clinic personnel) may enter medical data related to a patient, medical procedure, staffing assignments, operating room assignments, and/or the like. This entered medical data may be stored in a data source 104 such that it is accessible by the apparatus 102. A personal communication device 112 may comprise a mobile communication device, such as, for example, a mobile phone, pager, or the like, that may be carried by a patient, doctor, nurse, or other medical staff person and is configured to receive updates regarding medical procedure data, patient status, and/or the like over the network 108. The post-anesthesia care unit display apparatus 114 may comprise any apparatus comprising one or more displays that is configured to receive and/or access data for display over the network 108 and display the data on at least one of the one or more displays. In an exemplary embodiment, the post-anesthesia care unit display apparatus 106 comprises one or more displays located in a post-anesthesia care unit of a hospital or medical clinic. The short stay display apparatus 116 may comprise any apparatus comprising one or more displays that is configured to receive and/or access data for display over the network 108 and display the data on at least one of the one or more displays. In an exemplary embodiment, the short stay display apparatus 106 comprises one or more displays located in a short stay area of a hospital or medical clinic.

FIG. 2 illustrates a block diagram of an apparatus 102 for facilitating display of medical procedure data on a surgical tracking display apparatus according to an exemplary embodiment of the present invention. In an exemplary embodiment, the apparatus 102 includes various means, such as a processor 120, memory 122, communication interface 124, user interface 126, and display controller 128 for performing the various functions herein described. These means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 120 comprises a plurality of processors. The plurality of processors may be embodied on a single computing device or may be distributed across a plurality of computing devices collectively configured to function as the apparatus 102. The plurality of processors may be in operative communication with each other and may be collectively configured to perform one or more functionalities of the apparatus 102 as described herein. In an exemplary embodiment, the processor 120 is configured to execute instructions stored in the memory 122 or otherwise accessible to the processor 120. These instructions, when executed by the processor 120, may cause the apparatus 102 to perform one or more of the functionalities of the apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. Although illustrated in FIG. 1 as a single memory, the memory 122 may comprise a plurality of memories. The plurality of memories may be embodied on a single computing device or distributed across a plurality of computing devices. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the apparatus 102 to carry out various functions in accordance with exemplary embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. For example, the memory 122 may store medical procedure data, procedure data units, and/or other data. The memory 122 may comprise a data source 104. This stored information may be stored and/or used by the display controller 128 during the course of performing their functionalities.

The communication interface 124 may be embodied as any device or means embodied in circuitry, hardware, a computer program product comprising computer readable program instructions stored on a computer readable medium (e.g., the memory 122) and executed by a processing device (e.g., the processor 120), or a combination thereof that is configured to receive and/or transmit data from/to another device, such as, for example, a data source 104, surgical tracking display apparatus 106, data entry terminal 110, personal communication device 112, post-anesthesia care unit display apparatus 114, short stay display apparatus 116, and/or the like, over the network 108. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with another computing device over the network 108. The communication interface 124 may be configured to receive and/or transmit data using any protocol that may be used for communications between computing devices over the network 108. The communication interface 124 may additionally be in communication with the memory 122, user interface 126, and/or display controller 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In embodiments wherein the apparatus 102 is embodied as one or more servers, aspects of the user interface 126 may be reduced or the user interface 126 may even be eliminated. The user interface 126 may be in communication with the memory 122, communication interface 124, and/or display controller 128, such as via a bus.

The display controller 128 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the display controller 128 is embodied separately from the processor 120, the display controller 128 may be in communication with the processor 120. The display controller 128 may further be in communication with one or more of the memory 122, communication interface 124, or user interface 126, such as via a bus.

In some embodiments, the display controller 128 is configured to access medical procedure data from one or more data sources 104. In this regard, the display controller 128 may be configured to access medical procedure data by retrieving medical procedure data from one or more data sources 106 over the network 108. Additionally or alternatively, one or more data sources 104 may be configured to provide medical procedure data to the apparatus 102 such that the medical procedure data is accessible by the display controller 128. The display controller 128 may be configured to access medical procedure data from one or more data sources 104 periodically (e.g., daily, hourly, or the like), in response to a user command, and/or the like.

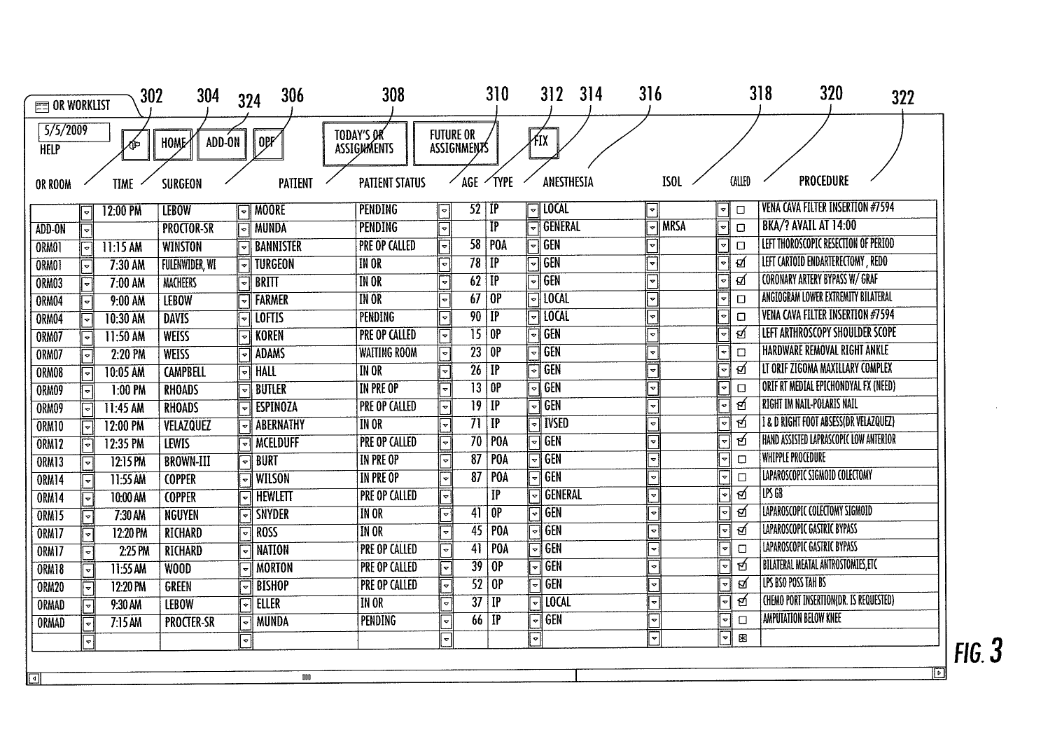

The medical procedure data accessed by the display controller 128 may include, for example, patient information, information about one or more medical procedures (e.g., surgical procedures) to be performed on a patient, medical personnel responsible for performing one or more medical procedures on a patient, an operating room in which a patient is scheduled to undergo one or more medical procedures, a time at which a patient is scheduled to undergo one or more medical procedures, medical personnel assigned to an operating room (OR), and/or the like. For example, FIG. 3 illustrates a screen capture of an operating room worklist for entering medical procedure data according to an exemplary embodiment of the present invention. In this regard, FIG. 3 illustrates a screen capture of a worklist that may be displayed to a user of a data entry terminal 110 for the purpose of entering medical procedure data to be stored at a data source 104, where it may be accessed by the display controller 128. The worklist of FIG. 3 includes several columns of medical procedure data related to medical procedures scheduled for patients. Column 302 comprises cells indicating an operating room in which a medical procedure is scheduled to be performed. Column 304 comprises cells indicating a time at which a medical procedure is to be performed. Column 306 comprises cells indicating a surgeon responsible for performing a medical procedure. Column 308 comprises cells indicating a patient on which a medical procedure is to be performed. Column 310 comprises cells indicating a status of a patient (e.g., pending, in operating room, in pre op, in waiting room, or the like). Column 312 comprises cells indicating an age of a patient. Column 314 comprises cells indicating a type of medical procedure to be performed (e.g., inpatient, outpatient, or the like). Column 316 comprises cells indicating a type of anesthesia to be performed for a medical procedure (e.g., local anesthesia, general anesthesia, or the like). Column 318 comprises cells indicating whether any isolation (ISOL) is required for a patient and, if so, what type of isolation. Column 320 comprises cells indicating whether a patient has been called to pre op yet. Column 322 comprises cells indicating a medical procedure to be performed on a patient. The “ADD-ON” button 324 allows a user of a data entry terminal 110 to create a new medical procedure record for addition to the worklist and populate data in the new medical procedure record. It will be appreciated, however, that FIG. 3 is provided merely for purposes of example and not by way of limitation. Accordingly, embodiments of the invention are not limited to the selection and organization of the data in the worklist of FIG. 3.

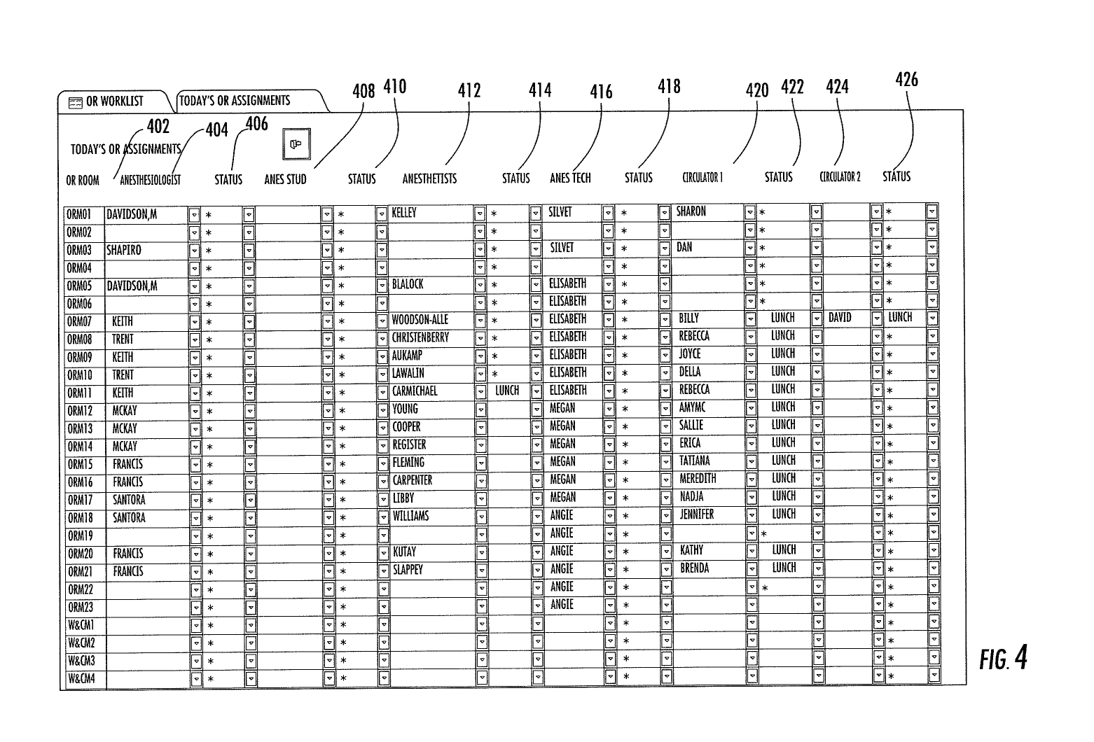

FIG. 4 illustrates a screen capture of an operating room assignment worklist according to an exemplary embodiment of the invention. In this regard, FIG. 4 illustrates a screen capture of a worklist that may be displayed to a user of a data entry terminal 110 for the purpose of entering medical procedure data to be stored at a data source 104, where it may be accessed by the display controller 128. The worklist of FIG. 4 includes several columns of medical procedure data related the staffing of operating rooms. In this regard, column 402 comprises a listing of operating rooms. Each subsequent pair of columns comprises a medical staff person (e.g., an anesthesiologist, technician, nurse, or the like) staffed to the operating room of a respective row and a status of that medical staff person, respectively. For example, the cells of column 404 indicate an anesthesiologist assigned to a respective operating room and the cells of column 406 indicate a status (e.g., in operating room, at lunch, on call, or the like) of a respective anesthesiologist. It will be appreciated, however, that FIG. 4 is provided merely for purposes of example and not by way of limitation. Accordingly, embodiments of the invention are not limited to the selection and organization of the data in the worklist of FIG. 4.

In some embodiments of the invention, the display controller 128 is further configured to aggregate the accessed medical procedure data into one or more procedure data units based at least in part upon predefined aggregation criteria. A procedure data unit may be associated with a patient, with an operating room in which a medical procedure is scheduled to be performed on the patient, and/or with the medical procedure scheduled to be performed on the patient. A procedure data unit may comprise any aggregated medical procedure data, such as, for example, an identification of the patient with which the procedure data unit is associated, a time at which a medical procedure is scheduled to be performed on the patient, a physician performing the medical procedure, a type of the medical procedure (e.g., inpatient (IP), outpatient (OP), or the like), information about the medical procedure to be performed, a status of the patient with which the procedure data unit is associated, and/or the like. It will be appreciated, however, that other medical procedure data may be aggregated into a procedure data unit by the display controller 128 in addition to or in lieu of medical procedure data provided above for purposes of example.

Referring to the worklists of FIGS. 3-4 as an example, the display controller 128 may be configured to access at least some of the medical procedure data from the worklist of FIG. 3 and at least some of the medical procedure data from the worklist of FIG. 4. The display controller 128 may then aggregate the accessed data into one or more procedure data units, with each procedure data unit being associated with a single patient and comprising information related to one or more medical procedures to be performed on the patient. In this regard, the display controller 128 may selectively aggregate medical procedure data from a plurality of data sources into one or more procedure data units.

The predefined aggregation criteria based at least in part upon which the display controller 128 is configured to aggregate accessed medical procedure data in some embodiments may comprise any aggregation criteria for aggregating medical procedure data for a patient case into a procedure data unit. For example, the aggregation criteria may comprise aggregating medical procedure data for a plurality of medical staff persons scheduled to perform one or more medical procedures on a single patient in a single operating room at the same time into a single procedure data unit. In this regard, a data source(s) 104 may comprise a medical data record (e.g., a row in the worklist of FIG. 3) for each surgeon scheduled to perform a medical procedure on a patient. If two surgeons are scheduled to operate on a patient at the same time, the display controller 128 may be configured to aggregate medical procedure data records for the two surgeons that are related to medical procedure(s) to be performed on the same patient into a single procedure data unit. In another example, the aggregation criteria may comprise aggregating medical procedure data for a plurality of medical procedures scheduled to be performed on a single patient in a single operating room at the same time into a single procedure data unit. It will be appreciated that the multiple procedures being performed at the same time does not necessarily mean they are performed simultaneously, but rather that they are both performed in a single operating room session scheduled to begin at a certain time. In this regard, a data source(s) 104 may comprise a medical data record (e.g., a row in the worklist of FIG. 3) for each medical procedure to be performed on a patient even though the plurality of medical procedures are scheduled to be performed on the patient concurrently or at least in the same operating room session. The display controller 128 may then be configured to aggregate the medical procedure data records for the multiple medical procedures into a single procedure data unit comprising medical procedure information for a single patient case.

After aggregating the accessed medical procedure data into one or more procedure data units, the display controller 128 is configured in some embodiments of the invention to assign each procedure data unit to one of a plurality of groups. In this regard, each group may be associated with a single operating room, such as may be located in a hospital or medical clinic in which at least a portion of the system 100 is implemented. In an exemplary embodiment, each procedure data unit is associated with an operating room in which a medical procedure with which the procedure data unit is associated is scheduled to be performed. Accordingly, the display controller 128 may be configured to assign a procedure data unit to a group associated with the same operating room with which the procedure data unit is associated.

In some embodiments of the invention, the display controller 128 is additionally configured to order the procedure data units for each group. In this regard, the display controller 128 may be configured to order the procedure data units in a group based at least in part upon the time at which the medical procedure(s) associated with the procedure data unit is scheduled to be performed. For example, the display controller 128 may be configured to order the procedure data units in a group in chronological ordering of the times the medical procedures for the respective procedure data units are scheduled to be performed.

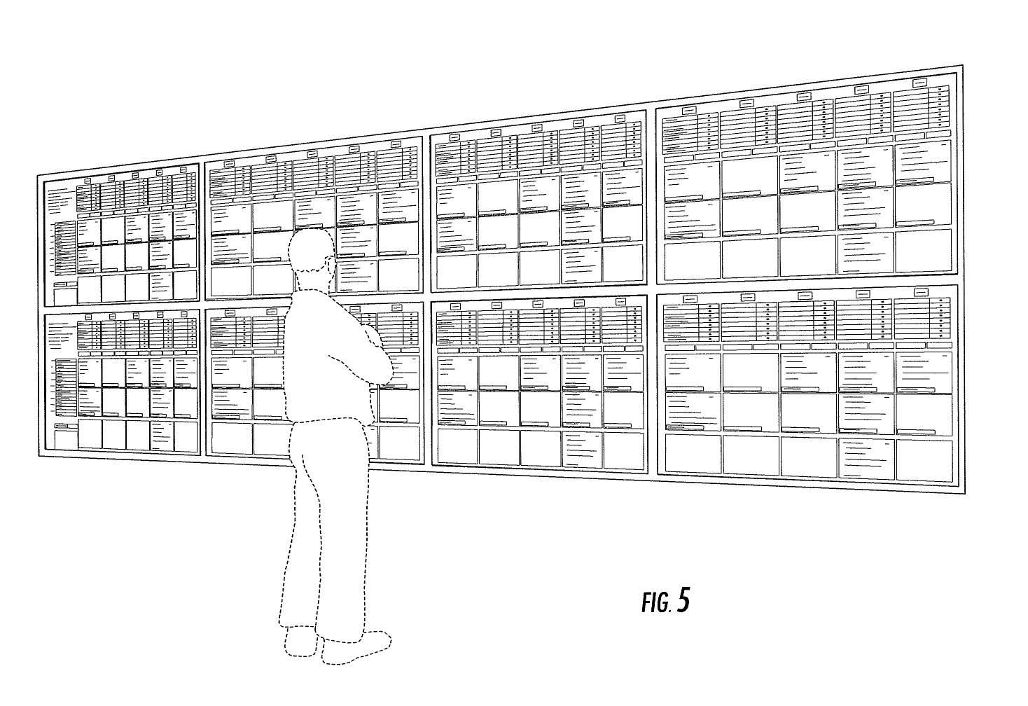

After ordering the procedure data units, the display controller 128 is configured in some embodiments to cause at least some of the ordered procedure data units to be displayed on the surgical tracking display apparatus 106, such as by sending data defining the procedure data units and a display ordering thereof to the surgical tracking display apparatus 106 such that the surgical tracking display apparatus 106 is enabled to display the procedure data units. Referring to FIG. 5, FIG. 5 illustrates a perspective view of a surgical tracking display apparatus 106 according to an exemplary embodiment of the invention. In this regard, the surgical tracking display apparatus 106 of the embodiment illustrated in FIG. 5 comprises either one large panel display or a plurality of adjacent panel displays, such as may be mounted on a wall so that medical staff persons may view procedure data units displayed by the surgical tracking display apparatus 106.

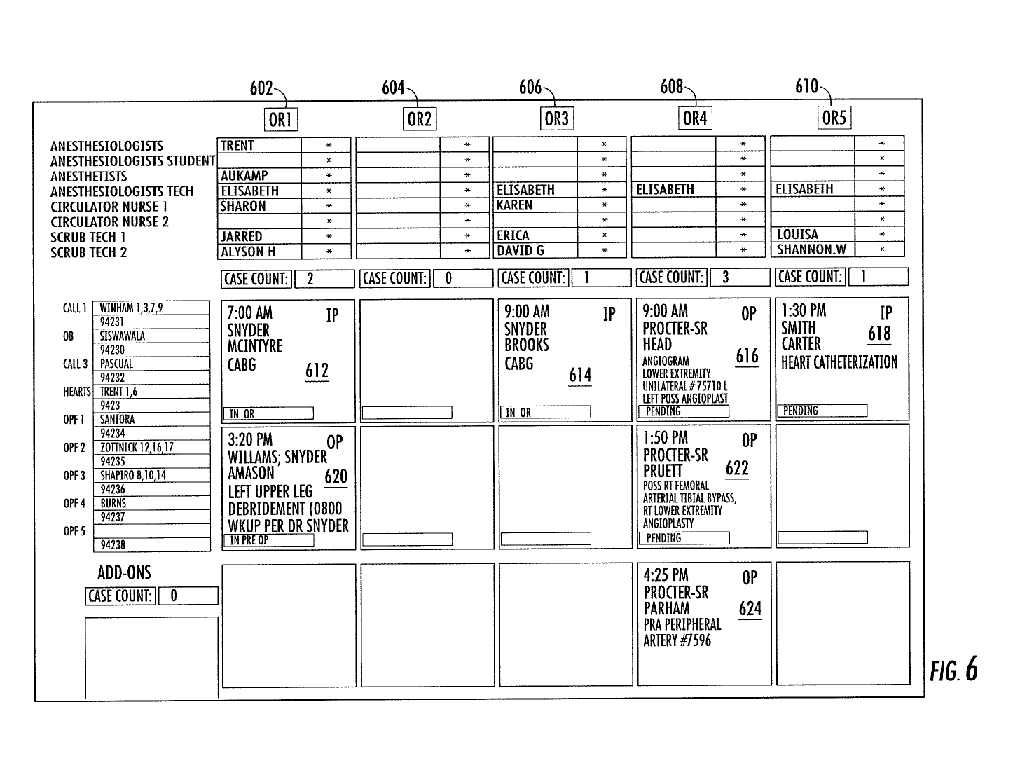

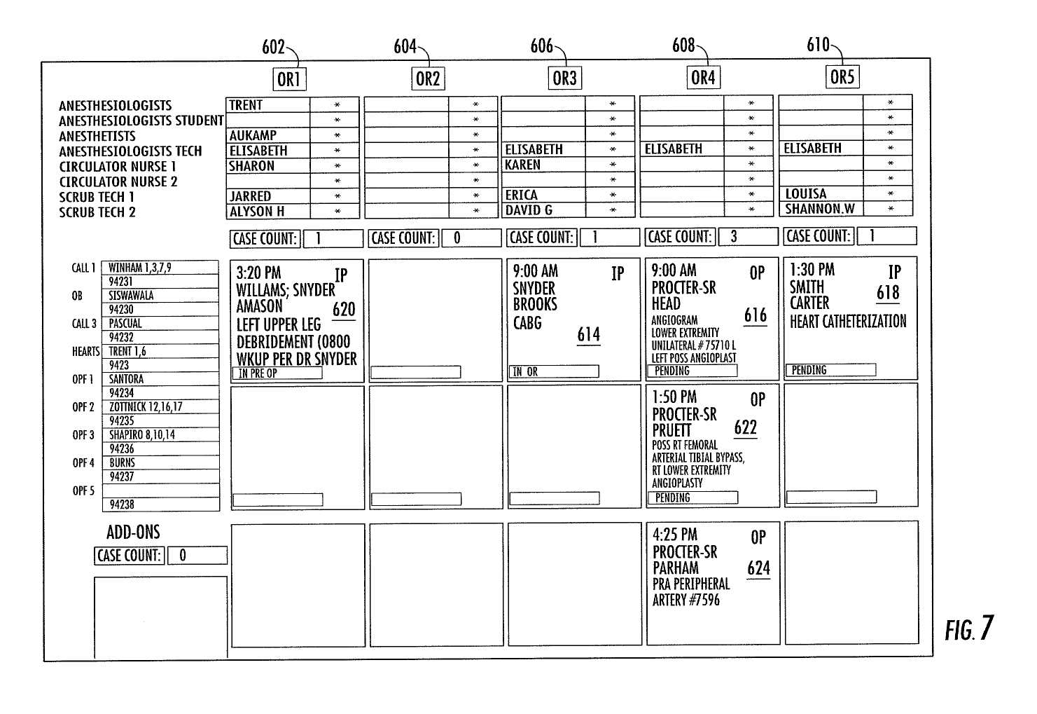

FIG. 6 illustrates medical procedure data displayed on a surgical tracking display apparatus according to an exemplary embodiment of the present invention. In this regard, the medical procedure data displayed in FIG. 6 may comprise a portion of the medical procedure data displayed on a surgical tracking display apparatus 106. It will be appreciated that the selection and arrangement of medical procedure data illustrated in FIG. 6 and ensuing FIGS. 7-9 is provided merely as an example of one embodiment of the invention and other embodiments may facilitate the display of different and/or differently arranged medical procedure data on a surgical tracking display apparatus 116. Referring to FIG. 6, the display comprises a plurality of columns, each of which is associated with an operating room (e.g., column 602 with OR1, column 604 with OR2, column 606 with OR3, column 608 with OR4, and column 610 with OR5). Accordingly, respective groups of procedure data units may be mapped to respective columns of the display based on the operating room with which a respective group and a respective column are associated. If the group comprises any procedure data units (e.g., if there is one or more medical procedure scheduled for the OR with which the group is associated), then at least one of the one or more ordered procedure data units of the group may be displayed in order in the column to which the group is mapped.

In FIG. 6, two procedure data units (612 and 620) are displayed in the column 602, indicating at least two medical procedure cases are scheduled for OR1. There are not any procedure data units displayed in the column 604, indicating that there may not be any medical procedure cases scheduled for OR2. One procedure data unit (614) is displayed in the column 606, indicating at least one medical procedure case is scheduled for OR3. Three procedure data units (616, 622, and 624) are displayed in the column 608, indicating at least three medical procedure cases are scheduled for OR4. One procedure data unit (618) is displayed in the column 610, indicating at least one medical procedure case is scheduled for OR5.

Referring for purposes of example to procedure data unit 612, each displayed procedure data unit in the embodiment of FIG. 6 includes a time at which one or more medical procedures are to be performed (e.g., “7:00 AM” for procedure data unit 612), a type of medical procedure(s) (e.g., “IP” for procedure data unit 612), one or more surgeons performing the medical procedure(s) (e.g., “SNYDER” for procedure data unit 612), a name of the patient on which the medical procedure(s) are being performed (e.g., “MCINTYRE” for procedure data unit 612), an indication of the medical procedure(s) being performed on the patient (e.g., “CABG” for procedure data unit 612), and a current status of the patient (e.g., “In OR” for procedure data unit 612). As illustrated in FIG. 6, the medical procedure of the procedure data unit 620 is scheduled to be performed at 3:20 PM in OR1 and thus in the embodiment of FIG. 6, the procedure data unit 620 is displayed below procedure data unit 612, as each of the columns is arranged in chronological order with the first scheduled procedure data unit in time for the operating room displayed first in the column associated with the operating room.

Referring now to procedure data unit 620, procedure data unit 620 illustrates an aggregation of medical procedure data by the display controller 128 into a single procedure data unit based at least in part upon the predefined aggregation criteria of aggregating multiple medical staff persons scheduled to perform one or more medical procedures on a single patient in a single operating room at the same time into a single procedure data unit. As displayed in the procedure data unit 620, two surgeons (“WILLIAMS” and “SNYDER”) are indicated as performing the “Left Upper leg Debridement” procedure. With reference to procedure data unit 622, procedure data unit 622 illustrates an aggregation of medical procedure data by the display controller 128 into a single procedure data unit based at least in part upon the predefined aggregation criteria of aggregating multiple medical procedures comprising a single case that are scheduled to be performed on a patient in a single operating room at the same time into a single procedure data unit. It will be appreciated that the multiple procedures being performed at the same time does not necessarily mean they are performed simultaneously, but rather that they are both performed in a single operating room session scheduled to begin at a certain time. As displayed in the procedure data unit 622, two medical procedures (“POSS RT FEMORAL ARTERIAL TIBIAL BYPASS” and “RT LOWER EXTREMITY ANGIOPLASTY”) are indicated as being performed on patient Pruett.

In an exemplary embodiment, the display controller 128 is configured to cause one or more ordered groups of procedure data units to be displayed on the surgical tracking display apparatus 106 without respect to a vertical axis. In this regard, in this exemplary embodiment, there is no time axis that the procedure data units are displayed with respect to and thus a procedure data unit from a first group may be displayed in a first column independent of a procedure data unit from a second group displayed in a second column. For example, procedure data unit 616 comprising the scheduled time 9:00 AM is displayed in column 608 adjacent to procedure data unit 618 comprising the scheduled time 1:30 PM. Accordingly, there may not be a time schedule correlation between procedure data units displayed adjacent each other in a row. A procedure data unit in this exemplary embodiment is instead displayed in a position relevant to any other procedure data units in the column in which the procedure data unit is displayed such that a case schedule is displayed for an OR in a column with the first procedure data unit for the first case in time for the OR displayed first regardless of the interval between a current time and the scheduled time for the first procedure data unit displayed in the column.

The display controller 128 may be further configured to determine that performance of a medical procedure with which a procedure data unit displayed on the surgical tracking display apparatus 106 has been completed. In this regard, the display controller 128 may be configured to determine a user input into a data entry terminal 110, personal communication device 112, user interface of the apparatus 102, on a touch screen of the surgical tracking display apparatus 106, and/or the like indicating the procedure has been completed. Additionally or alternatively, the display controller 128 may be configured to determine that a predefined amount of time has elapsed since the procedure was begun and/or determine completion of the medical procedure through other means. In response to the determination that performance of the medical procedure was completed, the display controller 128 may be configured to cause the procedure data unit associated with the completed medical procedure to be removed such that it is no longer displayed on the surgical tracking display apparatus. The display controller 128 may then be configured to cause each ordered procedure data unit in the same column (e.g., cases scheduled to be performed in the same OR) as the removed procedure data unit to be moved up in the column to replace the display space vacated by the removed procedure data unit. FIG. 7 illustrates medical procedure data displayed on a surgical tracking display apparatus according to an exemplary embodiment of the present invention. In this regard, FIG. 7 illustrates the display of FIG. 6 following completion of the medical procedure associated with procedure data unit 612. As illustrated in FIG. 7, procedure data unit 612 is no longer displayed and procedure data unit 620 (e.g., the next scheduled case for OR1) has been moved to the top of the column in place of the space vacated by procedure data unit 612.

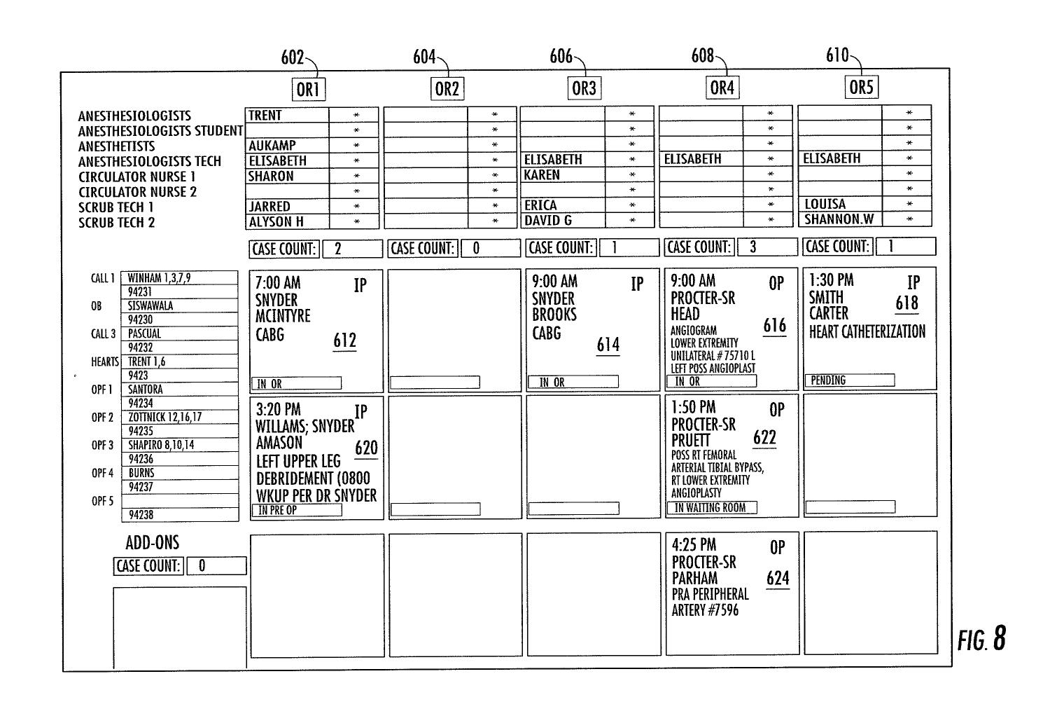

In some embodiments, the display controller 128 is configured to determine that a status of a patient with which a displayed procedure data unit is associated has been updated. For example, when a patient arrives at the hospital, the patient may check into a waiting room. In another example, a patient may be called back to a Pre-Op area. In still a further example, a patient may be taken into the OR. This status of the patient may be updated by a medical staff person by entering data into a data entry terminal 110, personal communication device 112, user interface of the apparatus 102, on a touch screen of the surgical tracking display apparatus 106, and/or the like. This status update may then be conveyed to the apparatus 102 and/or accessed from a data source 104 by the display controller 128. When the display controller 128 determines that a patient status has been updated, the display controller 128 may be configured to update an indication of the status of the patient displayed in the displayed procedure data unit associated with the patient. For example, FIG. 8 illustrates the display of FIG. 6 following update of the status of the patient associated with procedure data units 616 and 622. With reference to procedure data unit 616, the status of patient Head has been changed from “PENDING” to “In OR”. With reference to procedure data unit 622, the status of patient Pruett has been changed from “PENDING” to “IN WAITING ROOM” in response to patient Pruett's arrival in a waiting room prior to his scheduled medical procedure.

The display controller 128 may be further configured to provide notice that the status of a patient associated with a procedure data unit has been updated to one or more of one or more medical staff persons responsible for performing the medical procedure(s) with which the procedure data unit is associated, one or more medical staff persons associated with the operating room with which the procedure data unit is associated, or the patient with which the procedure data unit is associated. In this regard, the display controller 128 may be configured to send a notification message to a personal communication device 112 associated with an individual to be notified. Thus, for example, a responsible medical staff person may be notified of a change in patient status. In another example, when a patient is called to pre-op, the display controller 128 may send a notification message to a personal communication device 112 of the patient to alert the patient to report to the pre-op area.

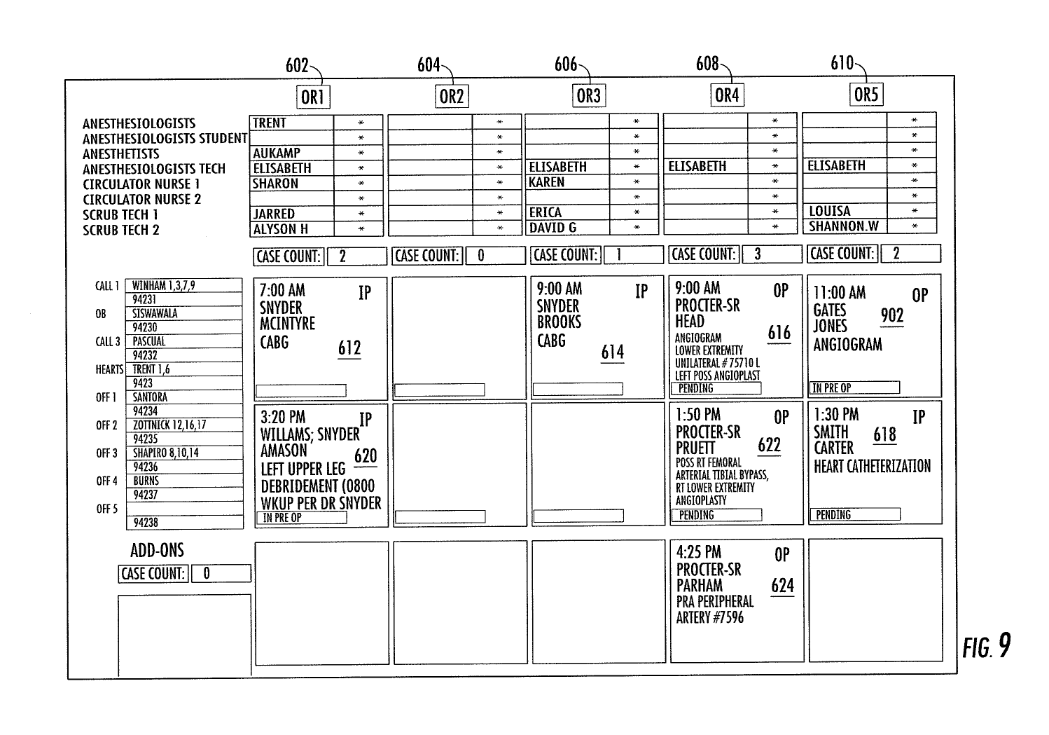

In some embodiments, the display controller 128 is configured to access medical procedure data for an add-on medical procedure to be performed in an operating room. In this regard, an add-on medical procedure may comprise a medical procedure that was not previously scheduled and for which medical procedure data was not previously aggregated into a procedure data unit by the display controller 128. For example, in embodiments wherein the display controller 128 is configured to aggregate accessed medical procedure data into procedure data units daily, an add-on medical procedure may not have been scheduled until the day it is scheduled to be performed. The display controller 128 may then be configured to access the medical procedure data for the add-on medical procedure and aggregate the medical procedure data for the add-on medical procedure into a new procedure data unit. The display controller 128 may then assign the new procedure data unit to the group associated with the operating room in which the add-on medical procedure is scheduled to be performed. The display controller 128 may then cause the new procedure data unit to be displayed on the surgical tracking display apparatus 106 in the column associated with the same operating room with which the new procedure data unit is associated. The display controller 128 may cause the new procedure data unit to be displayed in a position within the column that is ordered with respect to the time the add-on medical procedure is scheduled to be performed. For example, FIG. 9 illustrates the display of FIG. 6 following the addition of procedure data unit 902 for an add-on medical procedure. In this regard, the medical procedure associated with procedure data unit 902 is scheduled to be performed in OR5 at 11:00 AM. The medical procedure associated with procedure data unit 618, which was previously displayed at the top of column 610 is scheduled to be performed in OR5 at 1:30. Accordingly, in FIG. 9, the display controller 128 has caused procedure data unit 618 to be displayed further down the column to make room for new procedure data unit 902 to be displayed first in column 610, as it is now the next scheduled case for OR5.

In some embodiments, the display controller 128 is configured to transmit at least a portion of one or more procedure data units to personal communication device 112. The display controller 128 may be further configured to format the at least a portion of one or more procedure data units such that they are displayable on the personal communication device. This formatting may, for example, comprise formatting the at least a portion of one or more procedure data units for display on a smaller display of a personal communication device 112 and/or formatting the at least a portion of one or more procedure data units to a format compatible with hardware, operating system, software, and/or firmware capabilities of a personal communication device 112. For example, a personal communication device 112 may be associated with a surgeon. The display controller 128 may be configured to filter one or more procedure data units for procedure data units associated with a medical procedure to be performed by the surgeon. The display controller 128 may then provide the filtered procedure data units or at least a portion of the medical procedure data included therein to the surgeon's personal communication device 112. In this regard, a surgeon may be able to remotely access a surgical schedule, review patient information, and/or the like via his personal communication device 112.

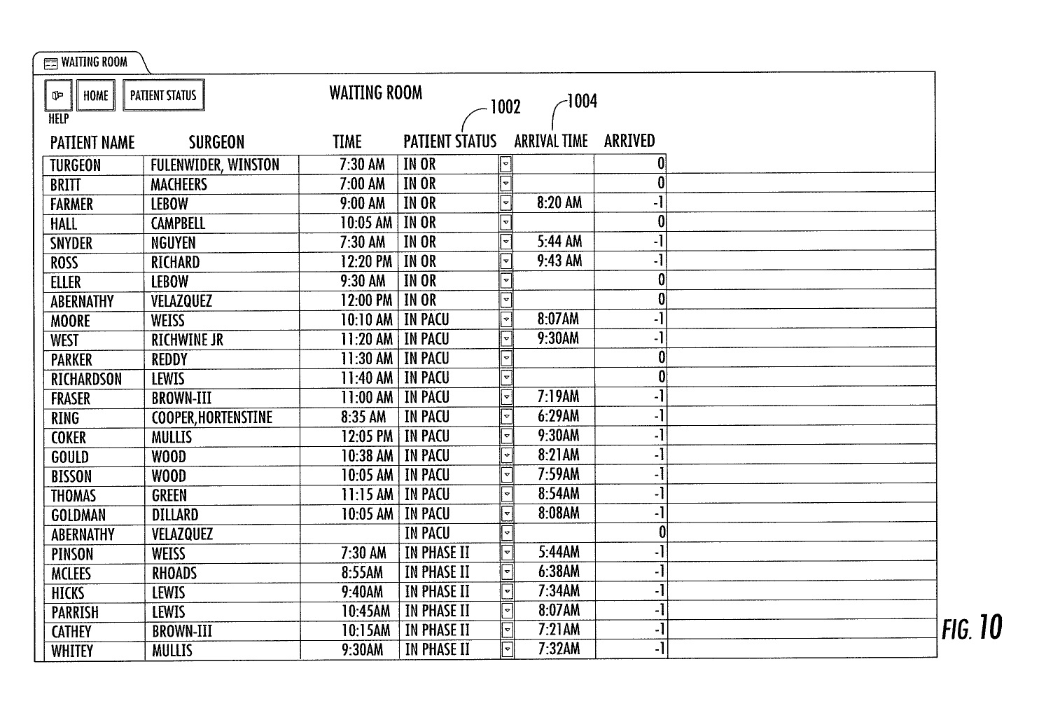

FIG. 10 illustrates a screen capture of a waiting room worklist according to an exemplary embodiment of the present invention. In this regard, the waiting room worklist of FIG. 10 may, for example, be displayed on a data entry terminal 110 located in a waiting room of a hospital or medical clinic. The waiting room worklist may allow a waiting room attendant to check patients in when they arrive and allow the waiting room attendant to adjust the patient status in the column 1002 and/or denote the patient's arrival time in column 1004. A change in the patient's status and/or denotation of a patient's arrival time may then be provided to the apparatus 102 by the data entry terminal 110 and/or may be otherwise accessed by the display controller 128 so that the display controller is enabled to update a patient status indicated by a procedure data unit.

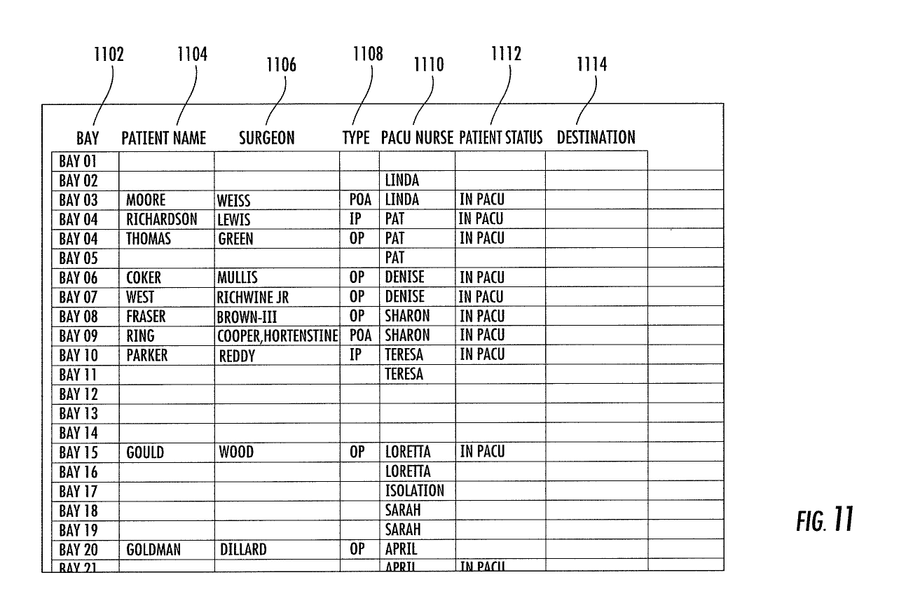

FIG. 11 illustrates medical data displayed on a post-anesthesia care unit display apparatus 114 according to an exemplary embodiment of the present invention. It will be appreciated that the arrangement of data in FIG. 11 is provided as an example of one embodiment of the invention and other embodiments may use a different selection and arrangement of information. In this regard, the display of FIG. 11 indicates a status of patients in one or more post-anesthesia care unit (PACU) bays. The display controller 128 may be configured to cause the data to be displayed on the post-anesthesia care unit display apparatus 114. In the embodiment illustrated in FIG. 11, the display controller is configured to cause a display comprising column 1102 vertically listing post-anesthesia care unit bay identifications, column 1104 listing patients staying in respective PACU bays, column 1106 listing surgeons overseeing respective patients, column 1108 indicating a patient/procedure type (e.g., IP, OP, or the like), column 1110 indicating a nurse assigned to a respective PACU bay, column 1112 indicating a patient status, and column 1114 that may indicate a destination of a patient after leaving the PACU to be displayed on the post-anesthesia care unit display apparatus 114.

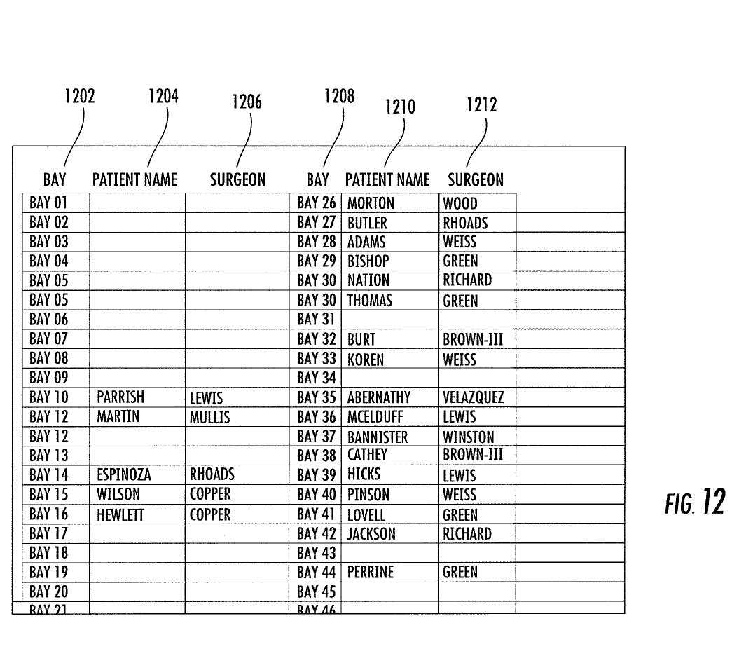

FIG. 12 illustrates medical data displayed on a short stay display apparatus 116 according to an exemplary embodiment of the present invention. It will be appreciated that the arrangement of data in FIG. 12 is provided as an example of one embodiment of the invention and other embodiments may use a different selection and arrangement of information. In this regard, the display of FIG. 12 indicates a status of one or more short stay bays. In the embodiment of FIG. 12, the display controller 128 is configured to cause a display comprising column 1202 vertically listing short stay bay identifications, column 1204 indicating patients staying in respective short stay bays, and column 106 indicating surgeons responsible for respective patients. In the embodiment of FIG. 12, the display controller 128 is configured to cause a multiple column unit format to be displayed such that columns 1208-1212, which comprise the same information as in columns 1202-1206 are also displayed to reduce an amount of vertical space required to display information for each short stay bay. It will be appreciated, however, that in other embodiments, the display controller 128 may be configured to cause only a single column unit to be displayed or may be configured to cause more than two column units to be displayed. The display controller 128 may be configured to determine the number of column units to be displayed on the short stay display apparatus 116 based at least in part upon a number of short stay bays in the hospital or medical clinic in which the system 100 is implemented (e.g., more short stay bays may require more column units) and/or on a vertical resolution of the short stay display apparatus 116 (e.g., the vertical resolution may affect how many short stay bay rows may be displayed vertically).

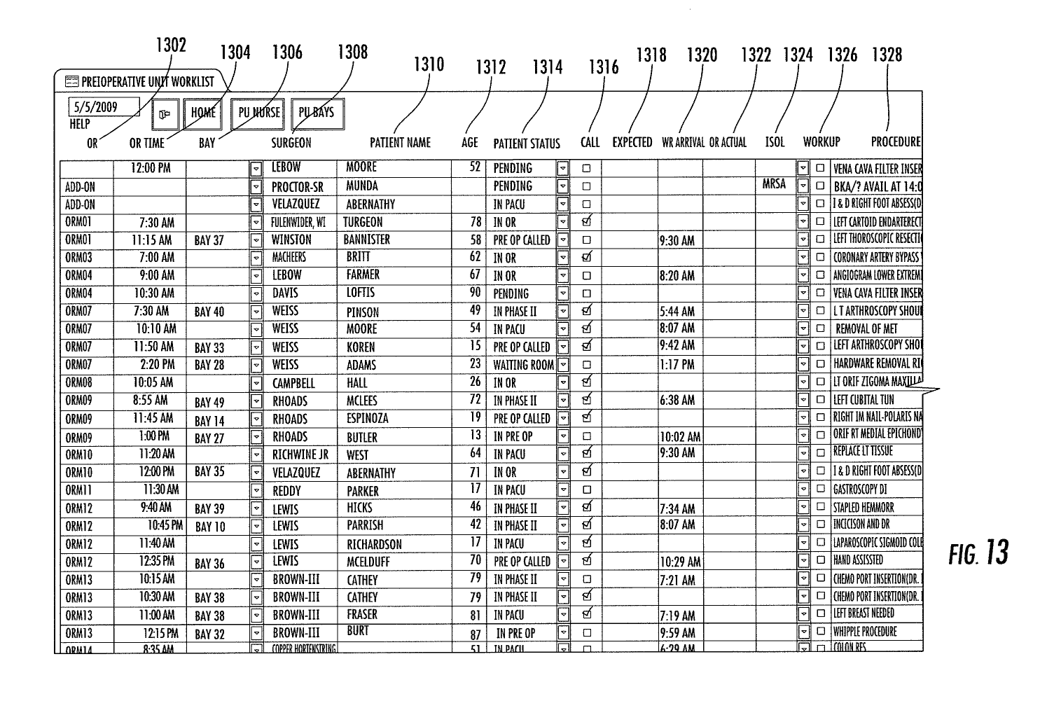

FIG. 13 illustrates a screen capture of a short stay worklist according to an exemplary embodiment of the present invention. In this regard, the short stay worklist of FIG. 13 may, for example, be displayed on a data entry terminal 110 located in a short stay area of a hospital or medical clinic. It will be appreciated that the selection and arrangement of medical information in the short stay worklist of FIG. 13 is provided as an example of one embodiment of the invention and not by way of limitation. Accordingly, in accordance with other embodiments of the invention, the short stay worklist may comprise a different selection and/or arrangement of medical information. The shortstay worklist may facilitate a medical staff person at a data entry terminal 110 to update patient information. This patient information may be stored in a data source 104 and may be accessible to the display controller 128 for use in aggregating into one or more procedure data units and/or updating existing procedure data units. The shortstay worklist may indicate an OR a patient is assigned to (column 1302), a scheduled OR time (column 1304), a short stay bay to which the patient is assigned (column 1306), a surgeon responsible for the patient (column 1308), the patient's name (column 1310), the patient's age (column 1312), the patient's status (column 1314), whether the patient has been called from the waiting room (column 1316), the patient's expected arrival time (column 1318), the patient's waiting room arrival time (column 1320), the patient's actual OR time (column 1322), whether the patient requires isolation (ISOL) and, if so, what type of isolation (column 1324), patient workup information (column 1326), an identification of a procedure to be performed on the patient (column 1328), and/or the like.

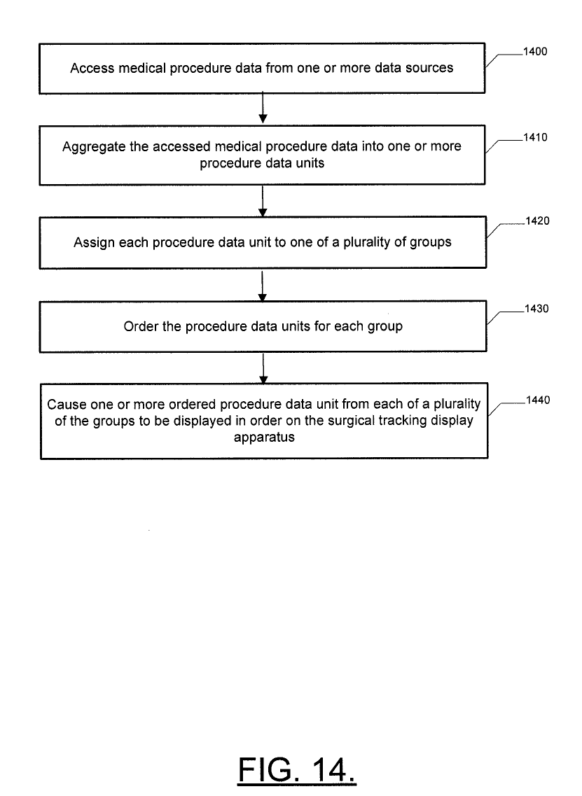

FIG. 14 illustrates a flowchart according to an exemplary method for facilitating display of medical procedure data on a surgical tracking display apparatus according to an exemplary embodiment of the invention. The method may include the display controller 128 accessing medical procedure data from one or more data sources 104, at operation 1400. Operation 1410 may comprise the display controller 128 aggregating the accessed medical procedure data into one or more procedure data units. The display controller 128 may then assign each procedure data unit to one of a plurality of groups, at operation 1420. In this regard, each group may be associated with a single operating room and the display controller 128 may assign a procedure data unit to a group associated with the same operating room with which the procedure data unit is associated. Operation 1430 may comprise the display controller 128 ordering the procedure data units for each group such that the procedure data units are ordered based at least in part upon a scheduled time at which a medical procedure associated with a procedure data unit is to be performed. Operation 1440 may comprise the display controller 128 causing one or more ordered procedure data unit from each of a plurality of the groups to be displayed in order on the surgical tracking display 106. In this regard, the display controller 128 may be configured to cause each displayed group to be displayed as a column without respect to a vertical axis.

FIG. 14 is a flowchart of a system, method, and computer program product according to exemplary embodiments of the invention. It will be understood that each block or step of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (e.g., the apparatus 102) and executed by a processor (e.g., the processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to medical personnel, patients, and computing devices. Embodiments of the invention provide an apparatus configured to access and aggregate medical procedure data from one or more data sources to generate medical procedure data units. Embodiments of the invention further provide an apparatus configured to cause the medical procedure data units to be displayed on a surgical tracking display apparatus so that medical personnel are enabled to easily view medical procedure data relating to medical procedures scheduled for operating rooms of a hospital or medical clinic. Embodiments of the invention additionally provide an apparatus configured to access medical data from and share medical data with a plurality of computing devices located in various areas of a hospital or medical clinic over a network.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for facilitating display of medical procedure data on a surgical tracking display apparatus, the method comprising:
accessing medical procedure data from one or more data sources;
aggregating the accessed medical procedure data into one or more procedure data units based at least in part upon predefined aggregation criteria, wherein each procedure data unit is associated with a patient, with an operating room in which a medical procedure is scheduled to be performed on the patient, and with the medical procedure scheduled to be performed on the patient, and wherein each procedure data unit comprises an identification of the patient and a time at which the medical procedure is scheduled to be performed;
assigning each procedure data unit to one of a plurality of groups, wherein each group is associated with a single operating room, and wherein each respective procedure data unit is assigned to the group associated with the operating room with which the respective procedure data unit is associated;
ordering the procedure data units for each group such that the procedure data units are ordered within each group based at least in part upon the time at which the medical procedure is scheduled to be performed; and
causing, by a display controller, one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

2. The method of claim 1, wherein causing the one or more ordered procedure data units from each of a plurality of the groups to be displayed comprises causing the one or more ordered procedure data units from each of the plurality of the groups to be displayed without respect to a vertical axis, such that the one or more ordered procedure data units from each respective group of the plurality of groups is displayed independent of the one or more ordered procedure data units from any other group.

3. The method of claim 1, further comprising:
determining that performance of a medical procedure with which a procedure data unit displayed on the surgical tracking display apparatus is associated has been completed;
causing, in response to the determination, the procedure data unit to be removed such that the removed procedure data unit is no longer displayed on the surgical tracking display apparatus; and
causing each ordered procedure data unit in the same column as the removed procedure data unit to be moved up the column to replace a display space vacated by the removed procedure data unit.

4. The method of claim 1, further comprising:
receiving medical procedure data for an add-on medical procedure to be performed in an operating room;
aggregating the received medical procedure data into a new procedure data unit;
assigning the new procedure data unit to the group associated with the operating room in which the medical procedure associated with the new procedure data unit is scheduled to be performed; and
causing the new procedure data unit to be displayed on the surgical tracking display apparatus in the column associated with the same operating room with which the new procedure data unit is associated in a position ordered relative to any other procedure data units in the column based at least in part upon the time at which the medical procedure associated with the new procedure data unit is scheduled to be performed.

5. The method of claim 1, wherein a displayed procedure data unit displayed on the surgical tracking display apparatus comprises an indication of a status of the patient with which the displayed procedure data unit is associated, and further comprising:
determining that the status of the patient with which the displayed procedure data unit is associated has been updated; and
updating the indication of the status of the patient in the displayed procedure data unit based at least in part upon the determination that the status of the patient with which the displayed procedure data unit is associated has been updated.

6. The method of claim 5, further comprising providing notice that the status of the patient with which the displayed procedure data unit is associated has been updated to one or more of one or more medical staff persons responsible for performing the medical procedure with which the displayed procedure data unit is associated, one or more medical staff persons associated with the operating room with which the displayed procedure data unit is associated, or the patient with which the displayed procedure data unit is associated.

7. The method of claim 1, wherein the predefined aggregation criteria comprises one or more of aggregating medical procedure data for a plurality of medical staff persons scheduled to perform one or more medical procedures on a single patient in a single operating room at the same time into a single procedure data unit or aggregating medical procedure data for a plurality of medical procedures scheduled to be performed on a single patient in a single operating room at the same time into a single procedure data unit.

8. The method of claim 1, wherein each procedure data unit further comprises one or more of an indication of the associated medical procedure to be performed on the patient, an identification of one or more medical staff persons responsible for performing the medical procedure scheduled to be performed on the patient, or a current status of the patient.

9. An apparatus for facilitating display of medical procedure data on a surgical tracking display apparatus, the apparatus comprising a processor configured to cause the apparatus to at least:
access medical procedure data from one or more data sources;
aggregate the accessed medical procedure data into one or more procedure data units based at least in part upon predefined aggregation criteria, wherein each procedure data unit is associated with a patient, with an operating room in which a medical procedure is scheduled to be performed on the patient, and with the medical procedure scheduled to be performed on the patient, and wherein each procedure data unit comprises an identification of the patient and a time at which the medical procedure is scheduled to be performed;
assign each procedure data unit to one of a plurality of groups, wherein each group is associated with a single operating room, and wherein each respective procedure data unit is assigned to the group associated with the operating room with which the respective procedure data unit is associated;
order the procedure data units for each group such that the procedure data units are ordered within each group based at least in part upon the time at which the medical procedure is scheduled to be performed; and
cause one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

10. The apparatus of claim 9, the processor is configured to cause the apparatus to cause the one or more ordered procedure data units from each of a plurality of the groups to be displayed by causing the one or more ordered procedure data units from each of the plurality of the groups to be displayed without respect to a vertical axis, such that the one or more ordered procedure data units from each respective group of the plurality of groups is displayed independent of the one or more ordered procedure data units from any other group.

11. The apparatus of claim 9, wherein the processor is further configured to cause the apparatus to:
determine that performance of a medical procedure with which a procedure data unit displayed on the surgical tracking display apparatus is associated has been completed;
cause, in response to the determination, the procedure data unit to be removed such that the removed procedure data unit is no longer displayed on the surgical tracking display apparatus; and
cause each ordered procedure data unit in the same column as the removed procedure data unit to be moved up the column to replace a display space vacated by the removed procedure data unit.

12. The apparatus of claim 9, wherein the processor is further configured to cause the apparatus to:
receive medical procedure data for an add-on medical procedure to be performed in an operating room;
aggregate the received medical procedure data into a new procedure data unit;
assign the new procedure data unit to the group associated with the operating room in which the medical procedure associated with the new procedure data unit is scheduled to be performed; and
cause the new procedure data unit to be displayed on the surgical tracking display apparatus in the column associated with the same operating room with which the new procedure data unit is associated in a position ordered relative to any other procedure data units in the column based at least in part upon the time at which the medical procedure associated with the new procedure data unit is scheduled to be performed.

13. The apparatus of claim 9, wherein a displayed procedure data unit displayed on the surgical tracking display apparatus comprises an indication of a status of the patient with which the displayed procedure data unit is associated, and wherein the processor is further configured to cause the apparatus to:
determine that the status of the patient with which the displayed procedure data unit is associated has been updated; and
update the indication of the status of the patient in the displayed procedure data unit based at least in part upon the determination that the status of the patient with which the displayed procedure data unit is associated has been updated.

14. The apparatus of claim 13, wherein the processor is further configured to cause the apparatus to provide notice that the status of the patient with which the displayed procedure data unit is associated has been updated to one or more of one or more medical staff persons responsible for performing the medical procedure with which the displayed procedure data unit is associated, one or more medical staff persons associated with the operating room with which the displayed procedure data unit is associated, or the patient with which the displayed procedure data unit is associated.

15. The apparatus of claim 9, wherein the predefined aggregation criteria comprises one or more of aggregating medical procedure data for a plurality of medical staff persons scheduled to perform one or more medical procedures on a single patient in a single operating room at the same time into a single procedure data unit or aggregating medical procedure data for a plurality of medical procedures scheduled to be performed on a single patient in a single operating room at the same time into a single procedure data unit.

16. The apparatus of claim 9, further comprising a memory storing instructions that when executed by the processor cause the apparatus to at least:
access the medical procedure data from the one or more data sources;
aggregate the accessed medical procedure data into one or more procedure data units;
assign each procedure data unit to one of the plurality of groups;
order the procedure data units for each group; and
cause the one or more ordered procedure data units from each of the plurality of the groups to be displayed.

17. A computer program product for facilitating display of medical procedure data on a surgical tracking display apparatus, the computer program product comprising at least one computer-readable storage medium having computer-readable program instructions stored therein, the computer-readable program instructions comprising:
a program instruction configured for accessing medical procedure data from one or more data sources;
a program instruction configured for aggregating the accessed medical procedure data into one or more procedure data units based at least in part upon predefined aggregation criteria, wherein each procedure data unit is associated with a patient, with an operating room in which a medical procedure is scheduled to be performed on the patient, and with the medical procedure scheduled to be performed on the patient, and wherein each procedure data unit comprises an identification of the patient and a time at which the medical procedure is scheduled to be performed;
a program instruction configured for assigning each procedure data unit to one of a plurality of groups, wherein each group is associated with a single operating room, and wherein each respective procedure data unit is assigned to the group associated with the operating room with which the respective procedure data unit is associated;
a program instruction configured for ordering the procedure data units for each group such that the procedure data units are ordered within each group based at least in part upon the time at which the medical procedure is scheduled to be performed; and
a program instruction configured for causing one or more ordered procedure data units from each of a plurality of the groups to be displayed in order on the surgical tracking display apparatus, wherein the displayed one or more ordered procedure data units for each respective group are displayed in a respective column of the surgical tracking display apparatus associated with the same operating room with which the respective group is associated.

18. The computer program product of claim 17, wherein the program instruction configured for causing the one or more ordered procedure data units from each of a plurality of the groups to be displayed comprises instructions configured for causing the one or more ordered procedure data units from each of the plurality of the groups to be displayed without respect to a vertical axis, such that the one or more ordered procedure data units from each respective group of the plurality of groups is displayed independent of the one or more ordered procedure data units from any other group.

19. The computer program product of claim 17, further comprising:
a program instruction configured for receiving medical procedure data for an add-on medical procedure to be performed in an operating room;
a program instruction configured for aggregating the received medical procedure data into a new procedure data unit;
a program instruction configured for assigning the new procedure data unit to the group associated with the operating room in which the medical procedure associated with the new procedure data unit is scheduled to be performed; and
a program instruction configured for causing the new procedure data unit to be displayed on the surgical tracking display apparatus in the column associated with the same operating room with which the new procedure data unit is associated in a position ordered relative to any other procedure data units in the column based at least in part upon the time at which the medical procedure associated with the new procedure data unit is scheduled to be performed.

20. The computer program product of claim 17, wherein the predefined aggregation criteria comprises one or more of aggregating medical procedure data for a plurality of medical staff persons scheduled to perform one or more medical procedures on a single patient in a single operating room at the same time into a single procedure data unit or aggregating medical procedure data for a plurality of medical procedures scheduled to be performed on a single patient in a single operating room at the same time into a single procedure data unit.
